(19) United States
(12) Patent Application Publication
(10) Pub. No.: US 2006/0245749 A1
(43) Pub. Date: Nov. 2, 2006

(54) Photographing device and photographing method

(76) Inventor: Toshio Nakamura, Saitama (JP)

Correspondence Address: VENABLE LLP, P.O. BOX 34385, WASHINGTON, DC, 20045-9998, US

(21) Appl. No.: 10/562,226

(22) PCT Filed: Jun. 15, 2004
(86) PCT No.: PCT/JP04/08696

§ 371 Date: Dec. 23, 2005

(30) Foreign Application Priority Data
Jun. 27, 2003 (JP) 2003-184740

(51) Int. Cl. G03B 15/03

(52) U.S. Cl. 396/155

(57) ABSTRACT

A photographing apparatus and a photographing method for obtaining a proper photographing result even in an environment where it is influenced by natural light are provided. A photographing apparatus 10 for photographing an object has: an illuminating unit 20 which irradiates light of a wavelength of a small energy in the natural light to an object; and a photographing unit 30 which obtains reflection light of the light which has been irradiated from the illuminating unit and reflected by the object and obtains a video image of the object on the basis of the obtained reflection light.

### BACKGROUND OF THE INVENTION

### 1. Field of the Invention

The invention relates to a photographing apparatus and a photographing method for photographing an object by using illumination.

Generally, an object is photographed in consideration of various conditions such as photographing time, photographing location, weather, and the like. For example, when short range photographing is executed at night, the photographing is executed by using illumination. Outdoor photographing in the daytime or photographing at the window in a room where natural light such as sun light, moonlight, or the like enters is executed without using illumination.

A video image photographed as mentioned above is used, for example, to authenticate the object. That is, data showing an iris of the object which has previously been photographed is stored as a database, a recognition target person is photographed, and data showing an iris of the recognition target person is collated with the database, thereby making authentication.

In the photographing for the iris authentication, near infrared rays having wavelengths near infrared rays are generally used for illumination day and night and information showing an image of the iris photographed by using the near infrared rays is used for the authentication.

However, when the photographing of the iris is performed outdoors, there is a case where the photographing is not properly performed. It has been found that there are the following causes of such a case.

When the photographing of the object is executed under the condition where the object is irradiated by the sun light, a shadow, reflection, or the like is caused by eyelashes or the like by the sun light whose light intensity is larger than that of the illumination, so that a desired photographed result cannot be obtained.

The natural light such as sun light or the like includes various wavelengths rather than the near infrared rays which are used to photograph. Light intensity of each of those wavelengths is generally larger than that of the near infrared rays which are used to photograph. Therefore, the indoor photographing using the near infrared rays for the illumination is largely influenced by the natural light and a desired photographed result cannot be obtained.

In consideration of the foregoing problems, it is an object of the invention to provide a photographing apparatus and a photographing method which can obtain a proper photographed result even under an environment where the photographing is influenced by the natural light.

### SUMMARY OF THE INVENTION

To solve the above problem, the invention uses the following construction.

There is provided a photographing apparatus for photographing an object, comprising: an illuminating unit which irradiates light of a band of a small energy in natural light to the object; and a photographing unit which obtains reflection light of the light which has been irradiated from the illuminating unit and reflected by the object and obtains a video image of the object on the basis of the obtained reflection light.

The illuminating unit can irradiate light including a plurality of wavelengths of the small energies in the natural light in the band.

The illuminating unit can irradiate light including a Fraunhofer line in the band of the small energy in the natural light.

The illuminating unit comprises: a light source unit which forms a light source having various wavelengths; and a low energy pass filter which allows the light of the band of the small energy in the natural light in the light source formed by the light source unit to pass.

The photographing unit comprises: a reflection light pass filter which obtains the reflection light; and a photoelectric converting unit which converts the reflection light which has passed through the filter into an electric signal.

There is provided an organism information recognizing system for recognizing an object on the basis of organism information which is formed on the basis of a video image of the object, comprising a photographing apparatus having: an illuminating unit which irradiates light of a band of a small energy in natural light to the object; and a photographing unit which obtains reflection light of the light which has been irradiated from the illuminating unit and reflected by the object and obtains the video image of the object on the basis of the obtained reflection light.

The organism information recognizing system can recognize an iris of the object as organism information.

The organism information recognizing system can recognize a face of the object as organism information.

The organism information recognizing system can recognize a retina of the object as organism information.

The organism information recognizing system can recognize a fingerprint of the object as organism information.

A moving body monitoring system for analyzing a locus of an object on the basis of a video image of the object and monitoring a line of flow of the object, comprising a photographing apparatus having: an illuminating unit which irradiates light of a band of a small energy in natural light to the object; and a photographing unit which obtains reflection light of the light which has been irradiated from the illuminating unit and reflected by the object and obtains the video image of the object on the basis of the obtained reflection light.

A traffic monitoring system for monitoring a traffic amount on the basis of a video image showing coming and going of an object, comprising a photographing apparatus having: an illuminating unit which irradiates light of a band of a small energy in natural light to the object; and a photographing unit which obtains reflection light of the light which has been irradiated from the illuminating unit and reflected by the object and obtains a video image of the object on the basis of the obtained reflection light.

A photographing method of photographing an object, comprising the steps of: irradiating light of a band of a small energy in natural light to the object; and obtaining reflection light of the irradiated light which has been reflected by the object and obtaining a video image of the object on the basis of the obtained reflection light.

The light includes a plurality of wavelengths of the small energies in the natural light.

A Fraunhofer line is included in the band of the small energy in the natural light.

There is provided an organism information recognizing method of recognizing an object on the basis of organism information of the photographed object, comprising the steps of: irradiating light of a band of a small energy in natural light to the object; and obtaining reflection light of the irradiated light which has been reflected by the object and obtaining a video image of the object on the basis of the obtained reflection light.

In the organism information recognizing method, an iris of the object is recognized as organism information.

In the organism information recognizing method, a face of the object is recognized as organism information.

In the organism information recognizing method, a retina of the object is recognized as organism information.

In the organism information recognizing method, a fingerprint of the object is recognized as organism information.

A moving body monitoring method of analyzing a locus of an object on the basis of a video image of the object and monitoring a line of flow of the object, comprising the steps of: irradiating light of a band of a small energy in natural light to the object; and obtaining reflection light of the irradiated light which has been reflected by the object and obtaining the video image of the object on the basis of the obtained reflection light.

A traffic monitoring method of monitoring a traffic amount on the basis of a video image showing coming and going of an object, comprising the steps of: irradiating light of a band of a small energy in natural light to the object; and obtaining reflection light of the irradiated light which has been reflected by the object and obtaining a video image of the object on the basis of the obtained reflection light.

### BRIEF DESCRIPTION OF THE DRAWINGS

FIG. 1 is a block diagram showing a photographing apparatus of the invention.

FIG. 2 is a diagram showing application examples of the photographing apparatus of the invention and each system.

FIG. 3 is a diagram showing a wavelength of a small energy near 656.3 nm.

FIG. 4 is a diagram showing a band including a plurality of wavelengths of small energies near 760 to 766 nm.

FIG. 5 is a block diagram showing an iris recognizing system.

FIG. 6 is a block diagram showing a face recognizing system.

FIG. 7 is a block diagram showing a retina recognizing system.

FIG. 8 is a block diagram showing a moving body monitoring system.

FIG. 9 is a block diagram showing a traffic monitoring system.

### DETAILED DESCRIPTION OF THE PREFERRED EMBODIMENTS

An embodiment of the invention will be described in detail hereinbelow.

### Embodiment 1

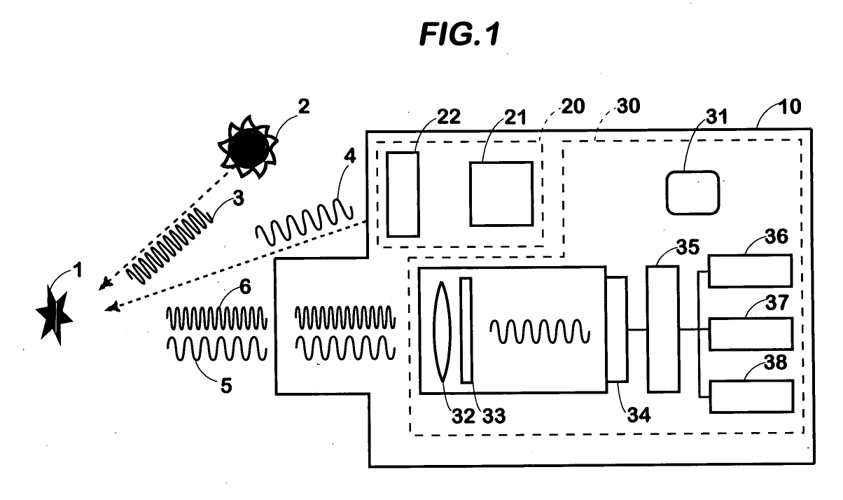

As shown in FIG. 1, a photographing apparatus 10 of the invention comprises: an illuminating unit 20 which irradiates illumination to an object 1; and a photographing unit 30 which obtains reflection light of the illumination which has been irradiated from the illuminating unit 20 and reflected by the object and obtains a video image of the object on the basis of the obtained reflection light.

The photographing apparatus 10 of the invention is provided outdoors in order to photograph the object 1 outdoors where sun light 3 from a sun 2 is irradiated.

The illuminating unit 20 comprises: a light source unit 21 for forming a light source including various wavelengths; and a light band pass filter 22 serving as a low energy pass filter for allowing light 4 of a band of a small energy in the natural light in the light source formed by the light source unit to pass.

The photographing unit 30 comprises: a photographing start switch 31 for receiving a photographing start instruction from the user; a lens 32 for receiving reflection light 5 reflected by the object 1 and the sun light 3; a reflection light band pass filter 33 serving as a reflection light pass filter for obtaining the reflection light 5 from each light received by the lens 32; a CCD (Charge Coupled Device) 34 serving as a photoelectric converting unit for converting the reflection light 5 which has passed through the reflection light band pass filter 33 into an electric signal; a CCD control unit 35 for controlling the CCD 34; a gate driving unit 36; a gate control unit 37;

and a power source unit 38 for driving each unit of the photographing apparatus 10.

When the photographing start switch 31 of the photographing unit 30 is pressed in order to photograph the object 1, the illuminating unit 20 is activated and the light is irradiated to the object. The irradiated light is reflected by the object 1 and the reflected light is converted as reflection light 5 into the electric signal by the CCD 34 of the photographing unit 30.

The reflection light 5 will now be described in detail. The reflection light 5 is light of the light 4 which has been irradiated from the illuminating unit 20 and reflected by the object 1. That is, the light 4 and the reflection light 5 are the light having substantially the same characteristics.

The sun light generally includes electromagnetic waves of various wavelengths and called ultraviolet rays, visible light, and infrared rays as the wavelength becomes longer. Fraunhofer as a German astronomer who analyzed a spectrum of the sun light comprising the electromagnetic waves of various wavelengths as mentioned above, has found out in 1814 that the electromagnetic waves of specific wavelengths included in the sun light become difficult to reach the surface of the Earth due to elements in the atmosphere of the sun or elements in the atmosphere of the Earth. In the electromagnetic waves which are difficult to reach the surface of the Earth, particularly, the wavelengths whose energies are especially smaller than energies in the natural light are called Fraunhofer lines or absorption lines and about 1000 or more wavelengths have been confirmed until the present.

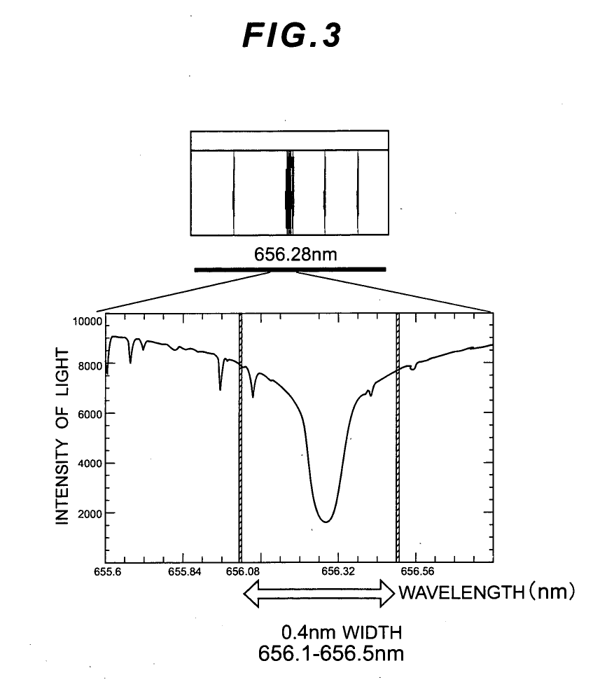

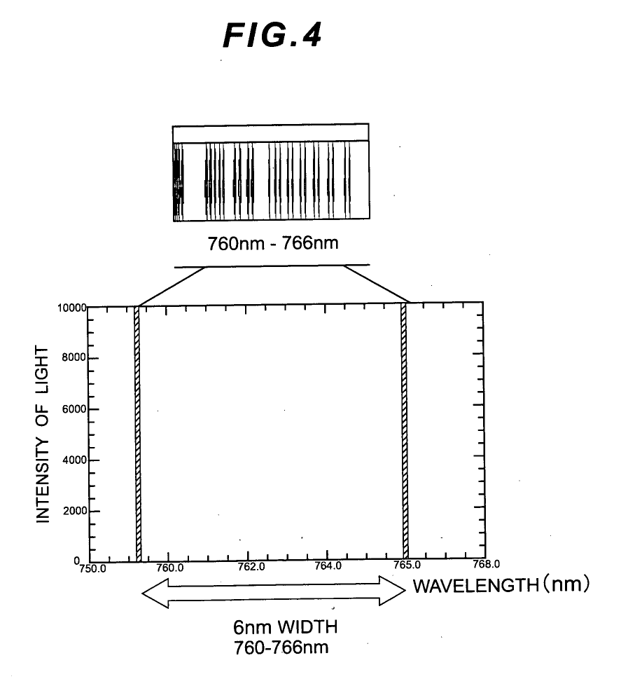

According to a certain Fraunhofer line, as shown in FIG. 3, the wavelength of about 656.28 nm is set to a wavelength center, an intensity of the light consisting of such a wavelength center, that is, an energy around such a wavelength is lower than those of other wavelengths and the light of such wavelengths become difficult to reach the surface of the Earth. As shown in FIG. 4, it has been confirmed that a plurality of Fraunhofer lines having such characteristics exist in a band of about 6 nm between about 760 nm and about 766 nm. The band of about 6 nm between about 760 nm and about 766 nm including such a number of Fraunhofer lines is a part of the band called near infrared rays. The photographing for iris recognition, which will be explained hereinafter, is executed by using the light in such a band for the illumination.

The light in the band mentioned above includes a plurality of wavelengths whose energies in the natural light are small. At the wavelengths whose energies in the natural light are small, particularly, the wavelength of the small energy in the natural light is called a Fraunhofer line.

According to the invention, since the light of the band including a number of wavelengths of the small energies in the natural light in which the foregoing Fraunhofer lines which are difficult to reach the Earth surface is artificially formed and the photographing is executed by using the formed light for the illumination, a photographing result to which a light amount of the light which was artificially formed has been reflected instead of a light amount of the sun light which reaches the Earth surface can be obtained.

The operation of the photographing apparatus of the invention will now be described.

The light source unit 21 of the illuminating unit 20 has emitters such as LEDs (Light Emitting Diodes) or the like and forms the light source including various wavelengths by using the LEDs.

The light source formed by the light source unit 21 passes through the light band pass filter 22 serving as a narrow band pass filter, so that the light 4 including a number of wavelengths of the low energies in the natural light mentioned above is formed. The formed light 4 is an electromagnetic wave of the band of about 6 nm between about 760 nm and about 766 nm and irradiated as illumination for the photographing onto the object 1.

At this time, if the photographing is executed outdoors, at the window, or the like, the sun light 3 from the sun 2 is also irradiated onto the object 1.

Reflection sun light 6 of the sun light 3 which has been reflected by the object 1 and the reflection light 5 of the light which has been irradiated from the light 4 and reflected by the object 1 are received by the lens 32 of the photographing unit 30.

The reflection light 5 and the reflection sun light 6 received by the lens 32 are sent to the reflection light band pass filter 33 serving as a narrow band pass filter in order to obtain the reflection light 5.

Since the reflection light band pass filter 33 which has received the reflection light 5 and the reflection sun light 6 allows the light of only the band between about 760 nm and about 766 nm to pass, it transmits the reflection light 5. When the transmitted reflection light 5 is sent to the CCD 34, it is converted into the electric signal by the CCD 34 controlled by the CCD control unit 35. A process such as signal amplification or the like is properly executed to the electric signal by the gate driving unit 36 which is controlled by the gate control unit 37. The processed signal shows the video image of the object in which the influence of the natural light such as reflection sun light 6 or the like is reduced.

In the photographing apparatus 10 of the invention, the light of the band of about 6 nm between about 760 nm and about 766 nm of the small energy in the natural light is formed by the illuminating unit 20 and irradiated onto the object 1, and the reflection light reflected by the object 1 is obtained by the photographing unit 30. Thus, generally, by photographing the object by using the light which is difficult to be detected on the ground surface, the video image of the object in which the influence of the natural light such as reflection sun light or the like is small can be obtained.

Although the light band pass filter 22 is used in the embodiment, the light 4 including the band between about 760 nm and about 766 nm may be formed by the conventional known method, for example, by using a cut filter or without using a filter.

Although the photographing has been performed by using the light of the band of about 6 nm between about 760 nm and about 766 nm in the embodiment, the invention is not limited to such an example. In order to allow the light of a band in which the energy is relatively smaller than that in the natural light to be used for the photographing, its band may be properly changed.

### Embodiment 2

An organism information recognizing system having the photographing apparatus 10 mentioned above will now be described with reference to the drawings.

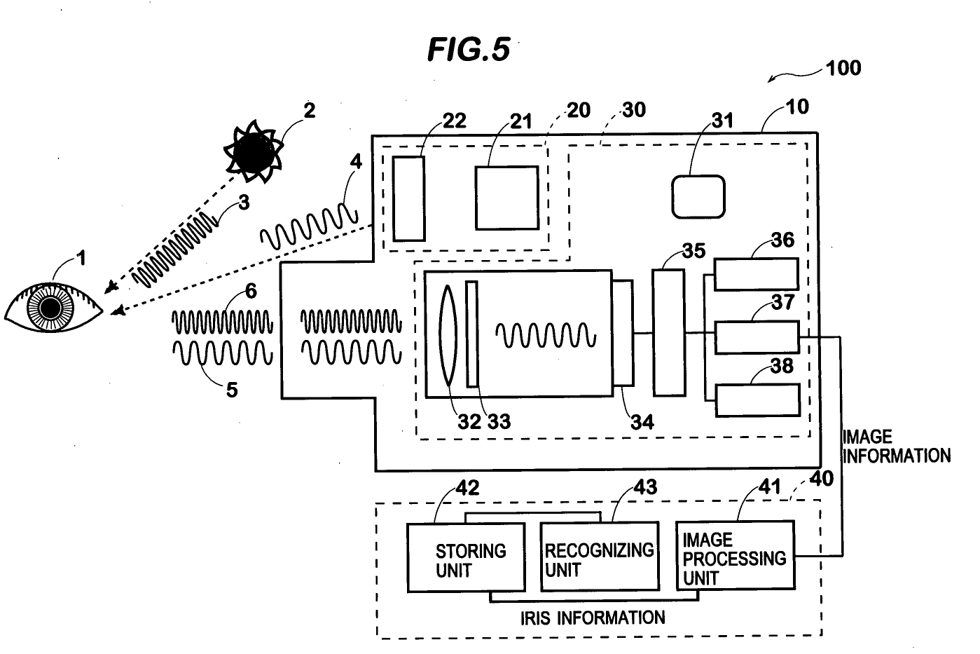

The organism information recognizing system is a system for recognizing an individual on the basis of organism information which can recognize the individual. An iris recognizing system 100 shown in FIG. 5 will now be described in detail as an example.

The iris recognizing system 100 comprises: the photographing apparatus 10 having the illuminating unit 20 which irradiates the illumination toward eyes of a face in order to recognize an iris of a pupil of a recognition target person and the photographing unit 30 which obtains the reflection light 5 of the illumination which has been irradiated from the illuminating unit 20 and reflected and obtains a video image of the eye on the basis of the obtained reflection light 5; and a processing apparatus 40 which forms iris information on the basis of the image information showing the video image of the eye obtained by the photographing apparatus 10.

The processing apparatus 40 comprises: an image processing unit 41 for obtaining the iris information showing a feature of the iris in the pupil on the basis of the image information showing the video image of the eye; a storing unit 42 for holding the iris information obtained by the image processing unit 41; and a recognizing unit 43 for recognizing the recognition target person on the basis of the iris information held in the storing unit 42.

Since a construction of each of the illuminating unit 20 and the photographing unit 30 of the photographing apparatus 10 of the iris recognizing system 100 is substantially the same as that of the embodiment 1, its explanation is omitted here.

Although the light including the Fraunhofer line called an O₂ line near 760 nm has been used for the illumination in the illuminating unit 20 of the embodiment 1 mentioned above, the light near 656.28 nm including the Fraunhofer line called an H_{α} line may be used for the illumination. Another light of the band in a range from 650 to 900 nm, mainly, the foregoing light whose energy in small in the natural light may be also used for illumination.

Besides the near-infrared rays and the infrared rays, the light of the band of the small energy in the visible light region may be also used.

The operation of the iris recognizing system 100 will now be described.

The light source unit 21 of the illuminating unit 20 forms the light source including various wavelengths by using the LEDs. The light source formed by the light source unit 21 passes through the light band pass filter 22, so that the light 4 of the band of the small energy in the natural light including the Fraunhofer line mentioned above is formed. As shown in FIG. 4, particularly, the light 4 of the band of about 6 nm between about 760 nm and about 766 nm is used here.

By using the light 4 of the band mentioned above, since a width of band is wide, control can be easily made and a selection range of the LEDs of the light source unit 21 is widened.

On the other hand, since the conventional photographing for recognition using the organism information such as an iris or the like is influenced by the natural light such as sun light (reflection sun light) or the like, generally, it is often performed indoors. That is, if the object is photographed outdoors, in spite of the fact that the same object is photographed, the results obtained by photographing the object differ every photographing in dependence on various outdoor conditions such as irradiation angle of the sun light, light amount, presence/absence of a shadow, presence/absence of irregular reflection, and the like. Therefore, even if it is intended to recognize the recognition target person on the basis of the image information which differs every photographing as mentioned above, since the recognition target person cannot be accurately recognized, the photographing to recognize the iris is often performed indoors.

According to the invention, in order to enable the photographing for the iris recognition to be performed outdoors, the light of the band of the small energy mentioned above is used for the illumination and the object is photographed. At this time, the reflection sun light 6 of the sun light 3 which has been irradiated from the sun 2 and reflected by the object 1 and the reflection light 5 of the light 4 which has been reflected by the object 1 are received by the lens 32 of the photographing unit 30.

The reflection light 5 and the reflection sun light 6 received by the lens 32 are sent to the reflection light band pass filter 33 for obtaining the reflection light 5.

The reflection light band pass filter 33 which has received the reflection light 5 and the reflection sun light 6 transmits the reflection light 5. When the transmitted reflection light 5 is sent to the CCD 34, it is converted into the electric signal by the CCD 34 under the control of the CCD control unit 35. A process such as signal amplification or the like is properly executed to the electric signal by the gate driving unit 36 which is controlled by the gate control unit 37. The processed signal is sent to the image processing unit 41 of the processing apparatus 40 as image information of an image data format showing the video image of the pupil in which the influence of the natural light is reduced.

On the basis of the image information showing the video image of the pupil, the image processing unit 41 obtains the video image showing the iris in the pupil as iris information. The obtained iris information is held in the storing unit 42.

On the basis of the iris information held in the storing unit 42, the recognition target person is recognized by the recognizing unit 43 by the conventional known method.

As mentioned above, according to the iris recognizing system 100 of the invention, since the light of the band of the small energy is used for the illumination and the information showing the iris of the recognition target person is obtained, the iris of the recognition target person is recognized on the basis of the information whose influence of the natural light is small. Therefore, the outdoor photographing for the iris recognition can be also properly performed.

Although the photographing has been performed by using the light of the band of about 760 nm, the invention is not necessarily limited to such an example. In order to allow the light of the band of the energy which is relatively smaller than that in the natural light to be used for the photographing, its band may be properly changed.

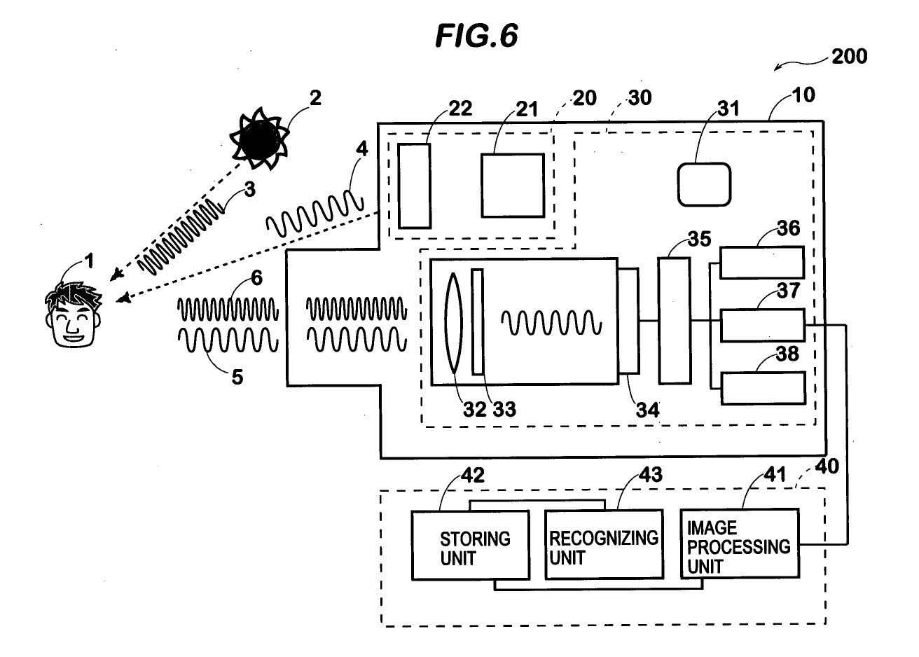

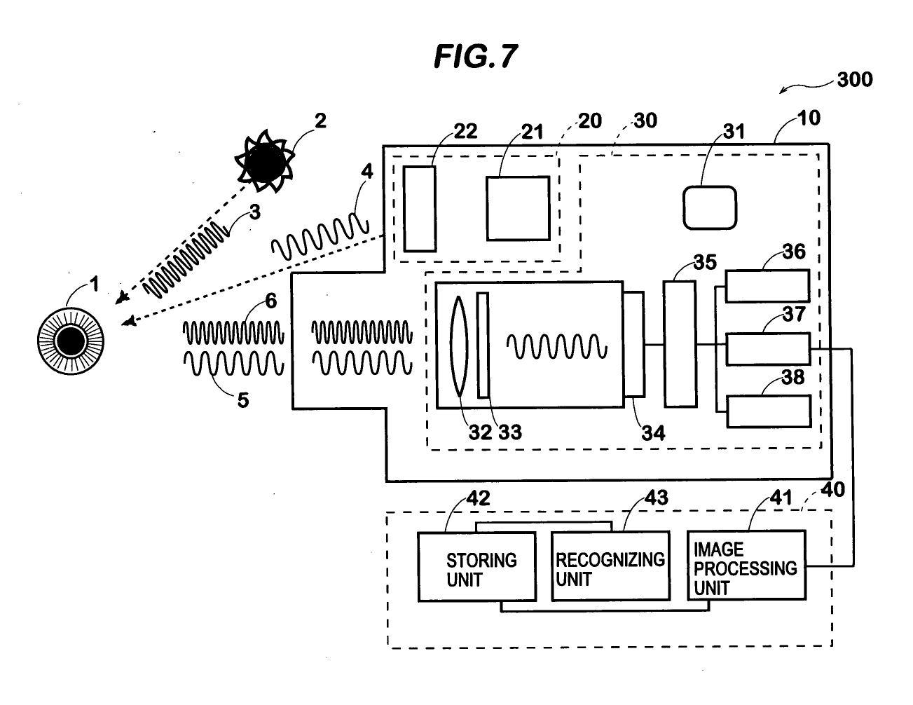

The foregoing iris recognizing system 100 is a system for recognizing on the basis of the information showing the iris. A face recognizing system 200 for recognizing on the basis of information showing the face in place of the information showing the iris is shown in FIG. 6. A retina recognizing system 300 for recognizing on the basis of information showing the retina is shown in FIG. 7.

Functions of processing apparatuses of the systems 200 and 300 differ in accordance with information contents to be processed.

For example, in the contents to be processed by the processing apparatus of the face recognizing system 200 shown in FIG. 6, the process for recognizing the recognition target person is executed on the basis of the information showing the face of the recognition target person. The processing apparatus of the retina recognizing system 300 shown in FIG. 7 executes the process for recognizing the recognition target person on the basis of the information showing the retina of the recognition target person.

That is, the image processing unit 41 of the processing apparatus 40 of the face recognizing system 200 obtains a video image of the face excluding the hair or the like as face information in an image data format on the basis of the image information showing the video image of the whole face and holds the obtained face information in the storing unit 42. The recognizing unit 43 recognizes the recognition target person by the conventional known method on the basis of the face information held in the storing unit 42.

According to the face recognizing system 200 of the invention, therefore, since the light of the band of the small energy is used for the illumination and the information showing the face of the recognition target person is obtained, the face of the recognition target person is recognized on the basis of the information in which the influence of the natural light is small. Thus, the outdoor photographing for the face recognition can be also properly performed.

On the basis of the image information showing the video image of the pupil, the image processing unit 41 of the processing apparatus 40 of the retina recognizing system 300 obtains a video image of the retina in the pupil as retina information in an image data format on the basis of the image information showing the video image of the pupil and holds the obtained retina information in the storing unit 42. The recognizing unit 43 of the retina recognizing system 300 recognizes the recognition target person by the conventional known method on the basis of the retina information held in the storing unit 42.

According to the retina recognizing system 300 of the invention, therefore, since the light of the band of the small energy is used for the illumination and the information showing the retina of the recognition target person is obtained, the retina of the recognition target person is recognized on the basis of the information in which the influence of the natural light is small. Thus, the outdoor photographing for the retina recognition can be also properly performed.

Although the above embodiment has been described with respect to the example in which the iris, face, or retina of the object is recognized as organism information, a fingerprint of the object can be also recognized as organism information.

### Embodiment 3

A moving body monitoring system 400 having the photographing apparatus 10 mentioned above will now be described with reference to the drawings.

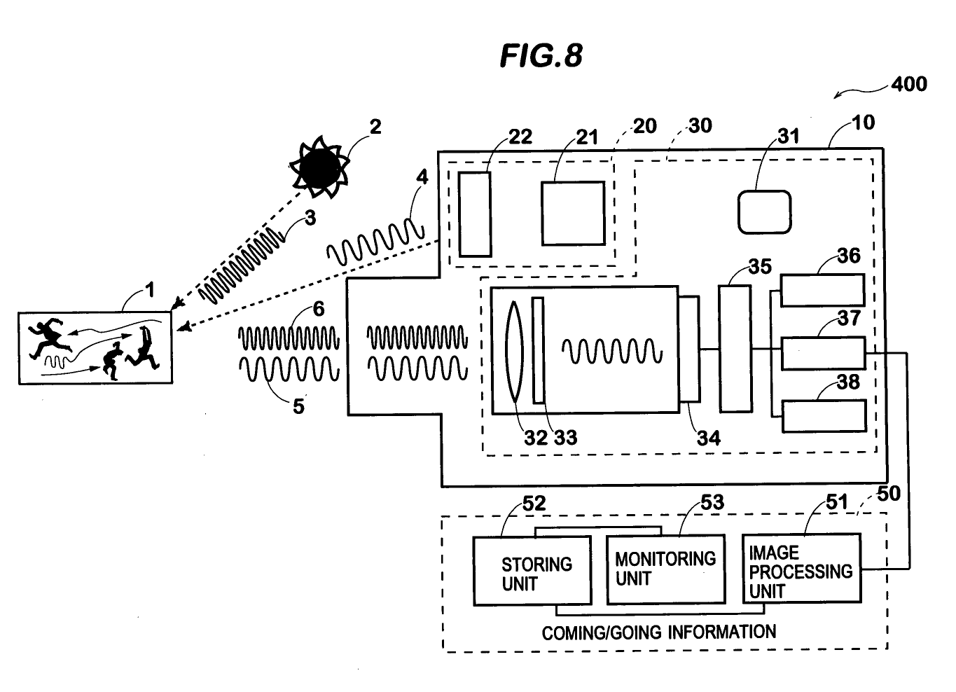

As shown in FIG. 8, the moving body monitoring system 400 comprises: the photographing apparatus 10 having the illuminating unit 20 which irradiates the light 4 toward the moving body 1 in order to monitor a line of flow of the moving body such as animal, human body, or the like and the photographing unit 30 which obtains the reflection light 5 of the illumination which has been irradiated from the illuminating unit 20 and reflected by the moving body 1 and obtains a video image of the moving body on the basis of the obtained reflection light 5; and a processing apparatus 50 which executes a process based on the image information showing the video image of the moving body obtained by the photographing apparatus 10.

The above processing apparatus 50 comprises: an image processing unit 51 for successively obtaining the image of the moving body in an image data format on the basis of the image information showing the video image of the moving body; a storing unit 52 for holding the image data obtained by the processing unit 51 as locus information; and a monitoring unit 53 for monitoring the line of flow of the moving body 1 on the basis of the locus information held in the storing unit 52.

Since a construction of each of the illuminating unit 20 and the photographing unit 30 of the photographing apparatus 10 of the moving body monitoring system 400 is substantially the same as that of the embodiment 1, its explanation is omitted here.

The operation of the moving body monitoring system 400 will now be described.

The light source unit 21 of the illuminating unit 20 forms the light source including various wavelengths by using the LEDs.

The light source formed by the light source unit 21 passes through the light band pass filter 22, so that the light 4 of the band of the small energy in the natural light including the Fraunhofer line mentioned above is formed. The formed light 4 is irradiated to the moving body 1.

On the other hand, since the conventional photographing for monitoring the moving body is generally often performed indoors where it is difficult to be influenced by the natural light. That is, if the photographing for monitoring the moving body is executed outdoors, in spite of the fact that the same moving body is successively photographed and its line of flow is monitored, it is erroneously judged that a line of flow of another moving body is monitored in dependence on various outdoor conditions such as irradiation angle of the sun light, light amount, presence/absence of a shadow, presence/absence of irregular reflection, and the like. There is a fear that the monitoring is interrupted or the operator loses sight of the moving body which is being monitored, so that it causes a problem.

According to the invention, to enable the photographing to monitor the moving body outdoors, the moving body 1 is photographed by using the light 4 of the band of the small energy mentioned above. At this time, the reflection sun light 6 of the sun light 3 which has been irradiated from the sun 2 and reflected by the moving body 1 and the reflection light 5 of the light 4 which has been reflected by the moving body 1 are received by the lens 32 of the photographing unit 30.

The reflection light 5 and the reflection sun light 6 received by the lens 32 are sent to the reflection light band pass filter 33 for obtaining the reflection light 5.

The reflection light band pass filter 33 which has received the reflection light 5 and the reflection sun light 6 allows the reflection light 5 to be transmitted. When the transmitted reflection light 5 is sent to the CCD 34, it is converted into the electric signal by the CCD 34 controlled by the CCD control unit 35. A process such as signal amplification or the like is properly executed to the electric signal by the gate driving unit 36 which is controlled by the gate control unit 37. The processed signal is sent to the image processing unit 51 of the processing apparatus 50 as image information showing the video image of the moving body in which the influence of the natural light is reduced.

The image processing unit 51 obtains locus information in an image data format showing a locus of the moving body 1 on the basis of the image information showing the video image of the moving body 1. The obtained locus information is held in the storing unit 52.

The monitoring unit 53 monitors a line of flow of the moving body 1 by the conventional known method on the basis of the locus information held in the storing unit 52.

As mentioned above, according to the moving body monitoring system 400 of the invention, since the light of the band of the small energy in the natural light is used for the illumination and the information showing the video image of the monitoring target person is obtained, the locus of the monitoring target person can be monitored on the basis of the information in which the influence of the natural light is small, so that the line of flow of the outdoor monitoring target person can be monitored.

### Embodiment 4

A traffic monitoring system 500 having the photographing apparatus 10 mentioned above will now be described with reference to the drawings.

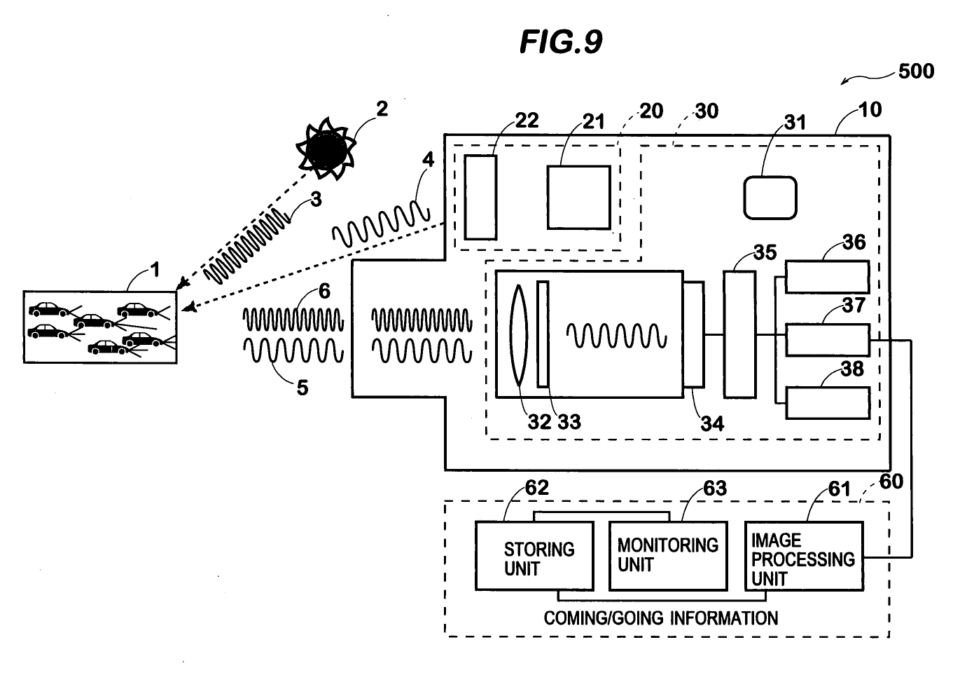

As shown in FIG. 9, in order to monitor coming and going of an object such as human body, vehicle, or the like, the traffic monitoring system 500 comprises: the photographing apparatus 10 having the illuminating unit 20 which irradiates the light 4 toward the vehicle 1 and the photographing unit 30 which obtains the reflection light 5 of the illumination which has been irradiated from the illuminating unit 20 and reflected by the vehicle 1 and obtains a video image of, for example, the vehicle 1 on the basis of the obtained reflection light 5; and a processing apparatus 60 which executes a process based on the image information showing the video image of the vehicle 1 obtained by the photographing apparatus 10.

The foregoing processing apparatus 60 comprises: an image processing unit 61 for successively obtaining the image showing coming and going of the vehicle 1 in an image data format on the basis of the image information showing the coming and going of the vehicle 1; a storing unit 62 for holding the image data obtained by the processing unit 61 as coming/going information; and a monitoring unit 63 for monitoring a traffic amount of the vehicle 1 as a monitoring target on the basis of the coming/going information held in the storing unit 62.

Since a construction of each of the illuminating unit 20 and the photographing unit 30 of the photographing apparatus 10 of the traffic monitoring system 500 is substantially the same as that of the embodiment 1, its explanation is omitted here.

The operation of the traffic monitoring system 500 will now be described.

The light source unit 21 of the illuminating unit 20 forms the light source including various wavelengths by using the LEDs. The light source formed by the light source unit 21 passes through the light band pass filter 22, so that the light 4 of the band of the low energy in the natural light including the Fraunhofer line mentioned above is formed. The formed light 4 is irradiated to the vehicle 1 as an object.

According to the conventional photographing to monitor the traffic amount, however, there is a case where, for example, in spite of the fact that only one vehicle comes and goes, such a video image that causes an erroneous judgment showing that a plurality of vehicles come and go is obtained due to an irradiation angle of the sun light, light amount, presence/absence of a shadow, irregular reflection, or the like, and it causes a problem.

According to the invention, in order to reduce the erroneous judgment in the traffic monitoring, the light 4 of the band of the small energy in the natural light is used for the illumination and the vehicle 1 is photographed. At this time, the reflection sun light 6 of the sun light 3 which has been irradiated from the sun 2 and reflected by the vehicle 1 and the reflection light 5 of the light 4 which has been reflected by the vehicle 1 are received by the lens 32 of the photographing unit 30.

The reflection light 5 and the reflection sun light 6 received by the lens 32 are sent to the reflection light band pass filter 33 to obtain the reflection light 5.

The reflection light band pass filter 33 which received the reflection light 5 and the reflection sun light 6 allows the reflection light 5 to be transmitted. When the transmitted reflection light 5 is sent to the CCD 34, it is converted into the electric signal by the CCD 34 controlled by the CCD control unit 35. A process such as signal amplification or the like is properly executed to the electric signal by the gate driving unit 36 which is controlled by the gate control unit 37. The processed signal is sent to the image processing unit 61 of the processing apparatus 50 as image information showing the video image of the vehicle in which the influence of the natural light is reduced.

The image processing unit 61 obtains traffic information in the image data format showing the coming and going of the vehicle 1 on the basis of the image information showing the image of the vehicle 1. The obtained traffic information is held in the storing unit 62. The monitoring unit 63 monitors the traffic amount of the vehicle 1 by the conventional known method on the basis of the traffic information held in the storing unit 62.

As mentioned above, according to the traffic monitoring system 500 of the invention, since the light of the band of the small energy in the natural light is used for the illumination and the information showing the information showing the video image of the monitoring target is obtained, the traffic amount of the monitoring target is monitored on the basis of the information in which the influence of the natural light is small. Therefore, the erroneous judgment of the traffic amount can be reduced.

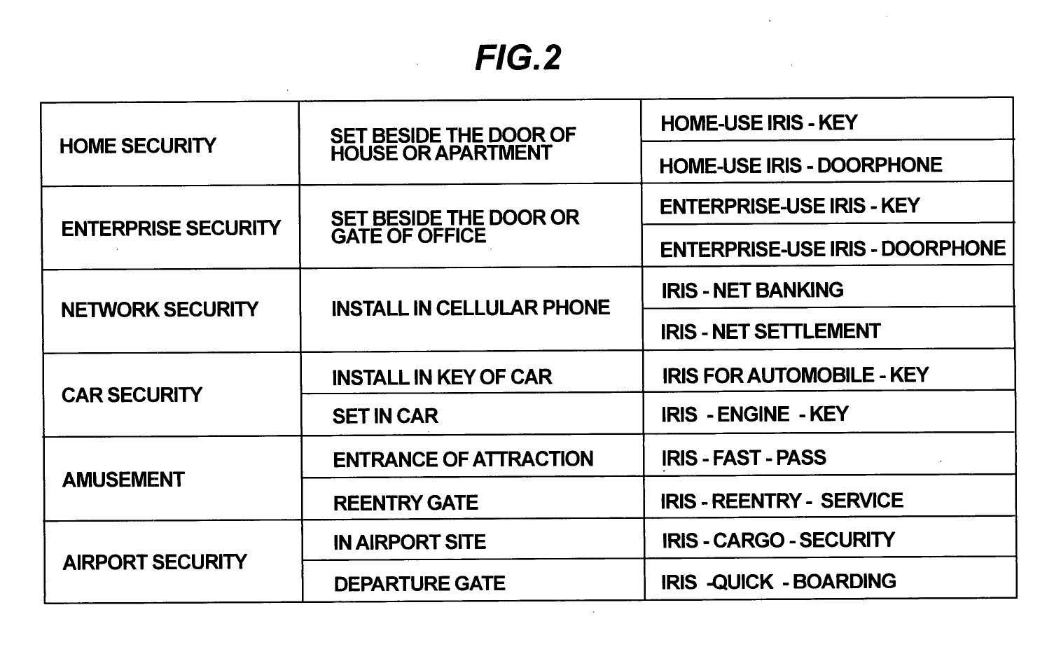

Each of the foregoing systems can be applied to various fields shown in FIG. 2. For example, it can be applied to security of doors and gate in/out of the room, security of a car stopped outdoors, network settlement by iris authentication using a cellular phone with a camera, entrance/exit management of attraction gates in an amusement park, security in an airport, admission management at a departure gate of the airport, and the like.

According to the invention, since the light of the band of the small energy in the natural light which is difficult to be detected on the surface of the Earth is irradiated onto the object and the video image of the object is obtained on the basis of the reflection light of the light which has been reflected by the object, the video image in which the influence of the natural light is small can be obtained.

What is claimed is:

1. A photographing apparatus for photographing an object, comprising:
an illuminating unit which irradiates light of a band of a small energy in natural light to the object; and
a photographing unit which obtains reflection light of the light which has been irradiated from said illuminating unit and reflected by said object and obtains a video image of said object on the basis of said obtained reflection light.

2. The apparatus according to claim 1, wherein said illuminating unit irradiates the light including a plurality of wavelengths of the small energies in the natural light in said band.

3. The apparatus according to claim 1, wherein said illuminating unit irradiates the light including a Fraunhofer line in the band of the small energy in said natural light.

4. The apparatus according to claim 1, wherein said illuminating unit comprises:
a light source unit which forms a light source having various wavelengths; and
a low energy pass filter which allows the light of the band of the small energy in the natural light in said light source formed by said light source unit to pass.

5. The apparatus according to claim 1, wherein said photographing unit comprises:
a reflection light pass filter which obtains said reflection light; and
a photoelectric converting unit which converts said reflection light which has passed through said filter into an electric signal.

6. An organism information recognizing system for recognizing an object on the basis of organism information which is formed on the basis of a video image of said object, comprising a photographing apparatus having:
an illuminating unit which irradiates light of a band of a small energy in natural light to the object; and
a photographing unit which obtains reflection light of the light which has been irradiated from said illuminating unit and reflected by said object and obtains the video image of said object on the basis of said obtained reflection light.

7. The system according to claim 6, wherein
said organism information recognizing system recognizes an iris of said object as organism information.

8. The system according to claim 6, wherein said organism information recognizing system recognizes a face of said object as organism information.

9. The system according to claim 6, wherein said organism information recognizing system recognizes a retina of said object as organism information.

10. The system according to claim 6, wherein said organism information recognizing system recognizes a fingerprint of said object as organism information.

11. A moving body monitoring system for analyzing a locus of an object on the basis of a video image of the object and monitoring a line of flow of said object, comprising a photographing apparatus having:
an illuminating unit which irradiates light of a band of a small energy in natural light to the object; and
a photographing unit which obtains reflection light of the light which has been irradiated from said illuminating unit and reflected by said object and obtains the video image of said object on the basis of said obtained reflection light.

12. A traffic monitoring system for monitoring a traffic amount on the basis of a video image showing coming and going of an object, comprising a photographing apparatus having:
an illuminating unit which irradiates light of a band of a small energy in natural light to the object; and
a photographing unit which obtains reflection light of the light which has been irradiated from said illuminating unit and reflected by said object and obtains a video image of said object on the basis of said obtained reflection light.

13. A photographing method of photographing an object, comprising the steps of:
irradiating light of a band of a small energy in natural light to the object; and
obtaining reflection light of the irradiated light which has been reflected by said object and obtaining a video image of said object on the basis of said obtained reflection light.

14. The method according to claim 13, wherein said light includes a plurality of wavelengths of the small energies in the natural light.

15. The method according to claim 13, wherein a Fraunhofer line is included in the band of the small energy in said natural light.

16. An organism information recognizing method of recognizing an object on the basis of organism information of the photographed object, comprising the steps of:
irradiating light of a band of a small energy in natural light to said object; and
obtaining reflection light of the irradiated light which has been reflected by said object and obtaining a video image of said object on the basis of said obtained reflection light.

17. The method according to claim 16, wherein an iris of said object is recognized as said organism information.

18. The method according to claim 16, wherein a face of said object is recognized as said organism information.

19. The method according to claim 16, wherein a retina of said object is recognized as said organism information.

20. The method according to claim 16, wherein a fingerprint of said object is recognized as said organism information.

21. A moving body monitoring method of analyzing a locus of an object on the basis of a video image of the object and monitoring a line of flow of said object, comprising the steps of:
irradiating light of a band of a small energy in natural light to the object; and
obtaining reflection light of the irradiated light which has been reflected by said object and obtaining the video image of said object on the basis of said obtained reflection light.

22. A traffic monitoring method of monitoring a traffic amount on the basis of a video image showing coming and going of an object, comprising the steps of:
irradiating light of a band of a small energy in natural light to the object; and
obtaining reflection light of the irradiated light which has been reflected by said object and obtaining a video image of the object on the basis of said obtained reflection light.
